(19) United States
(12) Patent Application Publication
(10) Pub. No.: US 2020/0381747 A1
(43) Pub. Date: Dec. 3, 2020

(54) Formulation of Interconnect of Fuel Cell

(71) Applicant: Porite Taiwan Co., Ltd., Miaoli (TW)

(72) Inventors: SHING YIN LIAO, Miaoli (TW); WEI HSUN HSU, Miaoli (TW); WEI PING HUANG, Miaoli (TW); HUEI LONG LEE, Miaoli (TW); CHIU LUNG CHU, Miaoli (TW)

(73) Assignee: Porite Taiwan Co., Ltd.

(21) Appl. No.: 16/828,143

(22) Filed: Mar. 24, 2020

(30) Foreign Application Priority Data
May 27, 2019 (TW) 108118291

(51) Int. Cl. H01M 8/0226; H01M 8/0208; C22C 27/06

(52) U.S. Cl. CPC H01M 8/0226; C22C 27/06; H01M 8/0208

(57) ABSTRACT

A formulation of an interconnect of a fuel cell includes chrome powder and chrome-iron alloy powder. A ratio of a sum of chrome in the chrome powder and the chrome-iron alloy powder is in a range between 80% in weight and 95% in weight, and a ratio of a sum of iron in the chrome powder and the chrome-iron alloy powder is in a range between 5% in weight and 20% in weight.

### BACKGROUND OF THE INVENTION

### 1. Technical Field

The present invention relates to a solid oxide fuel cell with interconnects, and more particularly to a formulation of an interconnect of a fuel cell.

### 2. Description of Related Art

In a high temperature fuel cell system, solid oxide fuel cell (SOFC) is a class of fuel cells using a solid oxide material as the electrolyte, such as cubic crystal stabilized zirconia, with a core temperature in a range between 700° C. and 1,000° C. Hydrogen is used as a fuel of SOFC, which may come from natural resources, such as alkane, or regenerated fuels, such as ethanol fuel. Hydrogen will be generated by reforming in a high temperature environment without the use of noble metal catalyst. Because of working in high temperature environment, SOFC may use various fuels, and it is an advantage of SOFC than the other fuel cells in the present market. SOFC produces electricity directly from oxidizing a fuel, which has an efficiency of 40% higher than the mechanical generators. Due to operating in high temperature environment, the waste heat of SOFC may be recycled for cogeneration to increase the efficiency more than 80%.

Interconnectors are the elements in SOFC for conducting the cathodes and the anodes of the neighboring cells. Only a limited voltage is generated in single cell, so that there must be a plurality of cells in series. Therefore, interconnects must have high conductivity in due environments.

Typically, the conventional SOFC includes a plurality of metallic interconnects for spacing the cells, conducting the cells, and providing a passageway of transmitting and removing fuel and oxidant. The conventional interconnects are made of Cr alloy or Cr—Fe—Y alloy. Both Cr—F alloy and Cr—Fe—Y alloy may keep its strength and size in the operating environment of SOFC, for example, operating temperature between 700° C. and 900° C. and in due environments of air and wet fuel.

Aforesaid Cr—F alloy and Cr—Fe—Y alloy are made by powder metallurgy. It takes a long time and has a high cost.

### BRIEF SUMMARY OF THE INVENTION

In view of the above, the primary objective of the present invention is to provide an interconnect of a fuel cell, which is easier to be manufactured.

In order to achieve the objective of the present invention, a formulation of an interconnect of a fuel cell includes chrome powder and the chrome-iron alloy powder, wherein a ratio of a sum of chrome in the chrome powder and the chrome-iron alloy powder is in a range between 80% in weight and 95% in weight.

The present invention further provides a formulation of an interconnect of a fuel cell, comprising chrome powder, iron powder and the chrome-iron alloy powder, wherein a ratio of a sum of chrome in the chrome powder, the iron powder and the chrome-iron alloy powder is in a range between 80% in weight and 95% in weight.

In an embodiment, the chrome-iron alloy powder is stainless steel powder.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of a preferred embodiment of the present invention;

FIG. 2 is a sketch diagram of the preferred embodiment of the present invention, showing the components of the first interconnect; and

FIG. 3 is a sketch diagram of the preferred embodiment of the present invention, showing the components of the second interconnect.

### DETAILED DESCRIPTION OF THE INVENTION

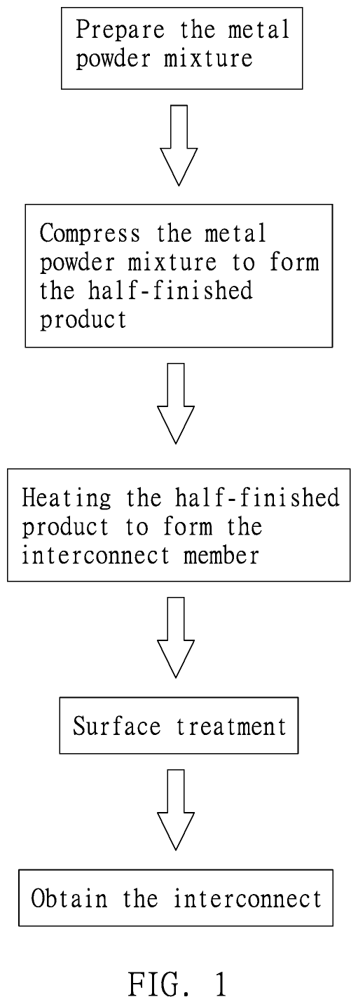

FIG. 1 shows a process of manufacturing an interconnect of a fuel cell, including preparing a metal powder mixture, compressing the metal power mixture to form a half-finished product, heating the half-finished product to form an interconnect member, and proceeding surface treatment to the interconnect member to obtain an interconnect. A composition of the metal powder mixture includes chromium (Cr) and iron (Fe), and a temperature of heating the half-finished product is equal to or higher than 1,350° C.

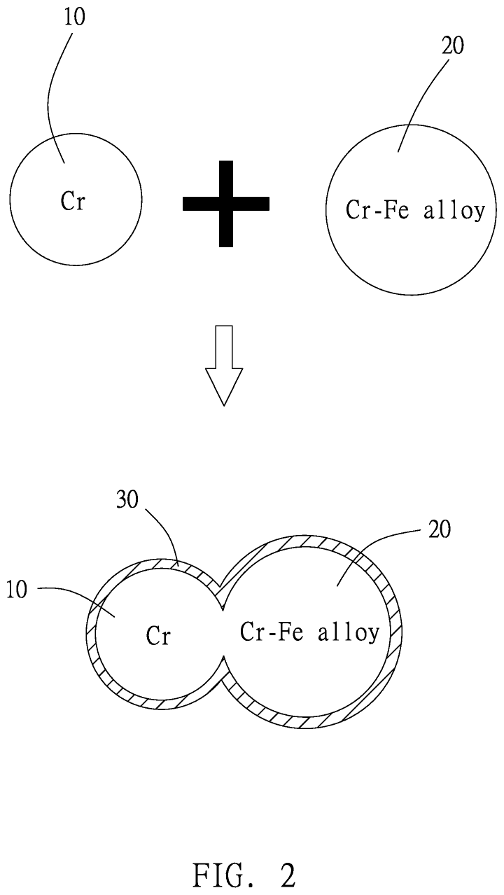

As shown in FIG. 2, a formulation of the metal powder mixture of a first interconnect includes chrome (Cr) powder 10 and chrome-iron (Cr—Fe) alloy powder 20. The metal powder mixture is compressed and heated as described above to form the first interconnect member, and then the first interconnect member is coated with an alloy layer 30 on a surface thereof to obtain the first interconnect.

The iron is provided by chrome-iron (Cr—Fe) alloy powder 20. In spite of the components of the metal powder mixture other than chrome (Cr) powder 10 and chrome-iron (Cr—Fe) alloy powder 20, a ratio of a sum of chrome (Cr) is in a range between 80% in weight and 95% in weight, and a ratio of a sum of iron (Fe) is in a range between 5% in weight and 20% in weight.

Chrome is provided by both the chrome (Cr) powder 10 and the chrome-iron (Cr—Fe) alloy powder 20 and iron is provided by the chrome-iron (Cr—Fe) alloy powder 20 instead of iron powder.

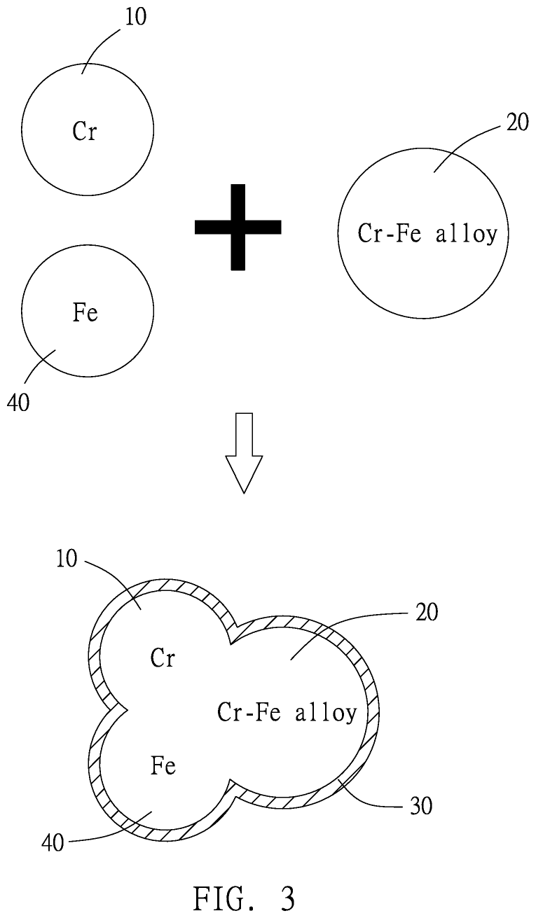

As shown in FIG. 3, the metal powder mixture of a second interconnect includes chrome (Cr) powder 10, iron (Fe) powder 40, and chrome-iron (Cr—Fe) alloy powder 20. The metal powder mixture is compressed and heated as described above to form a second interconnect member, and then the second interconnect member is coated with an alloy layer 30 on a surface thereof to obtain the second interconnect.

In spite of components of the metal powder mixture other than chrome (Cr) powder 10, iron (Fe) powder 40 and chrome-iron (Cr—Fe) alloy powder 20, a ratio of a sum of chrome (Cr) is in a range between 80% in weight and 95% in weight, and a ratio of a sum of iron (Fe) is in a range between 5% in weight and 20% in weight.

Chrome of the second interconnect is provided by both the chrome (Cr) powder 10 and the chrome-iron (Cr—Fe) alloy powder 20 and iron is provided by the iron (Fe) powder 40 and the chrome-iron (Cr—Fe) alloy powder 20.

The conventional interconnect is made by chrome (Cr) powder and iron (Fe) powder, and the present invention provides chrome-iron (Cr—Fe) alloy powder instead, which may have an easier heating procedure and have a stabilized properties of the interconnect after heating.

Since a range of the operating temperature of the interconnect is very large, the SOFC will be damaged if a coefficient of thermal expansion of the interconnect is not compatible to other related elements of SOFC. For example, a coefficient of thermal expansion of yttria stabilized zirconia (YSZ), which is widely used in SOFC, is in a range between 10×10⁻⁶/° C. and 11×10⁻⁶/° C. A ratio of iron in the chrome-iron alloy powder is in a range between 5% in weight and 30% in weight, and a coefficient of thermal expansion of the interconnect of the present invention is in a range between 9×10⁻⁶/° C. and 13×10⁻⁶/° C., which is very closed to the conventional yttria stabilized zirconia (YSZ).

Besides, the chrome-iron (Cr—Fe) alloy powder is cheaper and easier to get, which is helpful to cost down. In an embodiment, the chrome-iron (Cr—Fe) alloy is stainless steel powder.

The present embodiment defines a relative ratio of chrome and iron in the interconnect. The interconnect may have components other than chrome and iron, but the relative ratio of chrome and iron will not change.

It must be pointed out that the embodiments described above are only some preferred embodiments of the present invention. All equivalent structures which employ the concepts disclosed in this specification and the appended claims should fall within the scope of the present invention.

What is claimed is:

1. A formulation of an interconnect of a fuel cell, comprising chrome powder and chrome-iron alloy powder, wherein a ratio of a sum of chrome in the chrome powder and the chrome-iron alloy powder is in a range between 80% in weight and 95% in weight.

2. The formulation of claim 1, wherein a ratio of a sum of iron in the chrome powder and the chrome-iron alloy powder is in a range between 5% in weight and 20% in weight.

3. The formulation of claim 1, wherein the chrome-iron alloy powder is stainless steel powder.

4. The formulation of claim 1, wherein a ratio of iron in the chrome-iron alloy powder is in a range between 5% in weight and 30% in weight.

5. A formulation of an interconnect of a fuel cell, comprising chrome powder, iron powder and chrome-iron alloy powder, wherein a ratio of a sum of chrome in the chrome powder, the iron powder and the chrome-iron alloy powder is in a range between 80% in weight and 95% in weight.

6. The formulation of claim 5, wherein a ratio of a sum of iron in the chrome powder, the iron powder and the chrome-iron alloy powder is in a range between 5% in weight and 20% in weight.

7. The formulation of claim 5, wherein the chrome-iron alloy powder is stainless steel powder.

8. The formulation of claim 5, wherein a ratio of iron in the chrome-iron alloy powder is in a range between 5% in weight and 30% in weight.
